(19) United States
(12) Patent Application Publication
(10) Pub. No.: US 2021/0110473 A1
(43) Pub. Date: Apr. 15, 2021

(54) FIXED RISK CONTRACTS

(71) Applicant: Omaio Korero Limited Partnership, Auckland Central (NZ)

(72) Inventors: Roy Colin DAVIES, Auckland (NZ); Jonathan Rae LOWTHER, Auckland (NZ); Peter Nolan CHALMERS, Wellington (NZ)

(73) Assignee: Omaio Korero Limited Partnership, Auckland Central (NZ)

(21) Appl. No.: 16/949,001

(22) Filed: Oct. 8, 2020

Related U.S. Application Data
(60) Provisional application No. 62/912,923, filed on Oct. 9, 2019.

(51) Int. Cl. G06Q 40/04; G06Q 40/02; G06Q 10/10; G06Q 50/18; G06Q 40/08

(52) U.S. Cl. CPC G06Q 40/04; G06Q 40/025; G06N 7/005; G06Q 50/18; G06Q 40/08; G06Q 10/10

(57) ABSTRACT

A method comprising: receiving data; determining that the data match a specification of a fixed risk contract; determining, based on the data, that a threshold of the fixed risk contract has been met, wherein the threshold comprises a total quantum of a contract settlement reference methodology meeting the specification of the fixed risk contract; and triggering a payout of the fixed risk contract in response to the determination that a threshold of the fixed risk contract has been met. A method comprising: receiving extrinsic data; calculating a probability that a threshold of a fixed risk contract will be met based on the extrinsic data; calculating a margin for a short party of the fixed risk contract based on the probability.

### FIELD

This relates to a financial instrument.

### BACKGROUND

There are a large number of financial instruments which have been used over time. One category of these is derivatives which derive their value from the performance of an underlying entity. In some cases, derivatives may be used for hedging to minimise the risk arising from the underlying entity.

### SUMMARY

In a first aspect, there is provided a method comprising: receiving data; determining that the data match a specification of a fixed risk contract; determining, based on the data, that a threshold of the fixed risk contract has been met, wherein the threshold comprises a total quantum of a contract settlement reference methodology meeting the specification of the fixed risk contract; and triggering a payout of the fixed risk contract in response to the determination that a threshold of the fixed risk contract has been met.

In a second aspect, there is provided a method comprising: receiving extrinsic data; calculating a probability that a threshold of a fixed risk contract will be met based on the extrinsic data; calculating a margin for a short party of the fixed risk contract based on the probability.

### BRIEF DESCRIPTION OF THE DRAWINGS

The description is framed by way of example with reference to the drawings which show certain embodiments. However, these are provided for illustration only.

FIG. 1 shows an example of a fixed risk contract.

FIG. 2 shows an example of establishing a fixed risk contract.

FIG. 3 shows an example of a settlement process for a fixed risk contract.

FIG. 4 shows an example of dynamic margining for a fixed risk contract.

FIG. 5 shows an example system.

### DETAILED DESCRIPTION

Derivatives can have a useful function in hedging by allowing a party to mitigate risk of the underlying entity. Derivatives therefore rely strongly on the availability of pricing information for the underlying entity. Where the pricing information is unavailable, existing derivatives may not be usable to properly hedge risk.

One area in which there is risk but without clear pricing information is in catastrophic events. When these occur, the liability of insurers and other parties may be significant. However, because it may be difficult to identify a price of an underlying entity, there has been some difficulty with capturing the risk with a financial instrument. Some insurers and reinsurers have therefore been limited in their ability to properly hedge against risk.

An alternative to existing financial instruments is described below. This provides an approach which can be tied to the level of losses caused by events.

In particular, this provides an internal margining system based on non-correlation between contracts and conservative assessment for consecutive binary losses. All of the aforementioned forms a margining mesh that includes a myriad of internal insurance policies, takes account of seasonality, features a relationship between brokerage and margining, and is wrapped with a custom insurance policy over the overall capital picture. All this is measurable and knowable by existing financial practice from a known capital base.

A fixed risk contract (FRC) is one such financial instrument. The FRC aims to pay out a predetermined quantum if a contract settlement reference methodology (CSRM) has reached a threshold and is of a specified nature.

The CSRM may comprise one or more factors. For example, the CSRM may comprise a quantum of insurance claims. An insurance claim has a standardised lifecycle. A first point is when a covered event occurs and that causes an amount of damage to an insured party. A second point is when an insured party makes a claim for the damage. A third point is when an insurer accepts the claim. A fourth point is when the insurer approves the claim. A fifth point is when the insurer pays out the amount of the claim to the insured party.

The CSRM may comprise a factor based on one or more of these points in the lifecycle of an insurance claim. For example, the CSRM may consider the quantum of claims which have reached the third point. This may be expressed as event insured claims accepted (EICA). One benefit of considering EICA (rather than the amount actually paid out by the insurers) is the potential delay between an insurer accepting a claim and an insurer paying out in respect of the claim. This may allow the payout to be made more quickly. Where the payout is to an insurer or reinsurer, this ensures that the recipient receives the payout from the FRC before they are required to pay out in respect of the claims. This can mitigate a potential cashflow risk that could otherwise occur and optimises the use of FRCs for risk hedging. Other implementations of the FRC may consider one or more of the other points, or a combination of the points.

Additionally or alternatively, the CSRM may comprise an independent damage assessment (IDA). In some cases, the IDA may be derived by an entity engaged specifically for the purpose of generating the IDA. For example, the IDA may be derived by engineers or quantity surveyors who have been engaged to supply an estimated measure of damage to all property, insured or not. Such an advisor may be engaged by the exchange with the cost of such advisors incorporated within the contract.

Additionally or alternatively, the IDA may be derived, at least in part, through the use of an artificial intelligence system using satellite and/or street-level imagery. This can be used to predict or assess the damage caused. The artificial intelligence system may be managed or run by the exchange or by a separate party.

The FRC therefore has two parties: a long party and a short party. The long party is paid out by the short party if the CSRM exceeds the threshold before the expiry of the FRC.

### FRC Structure

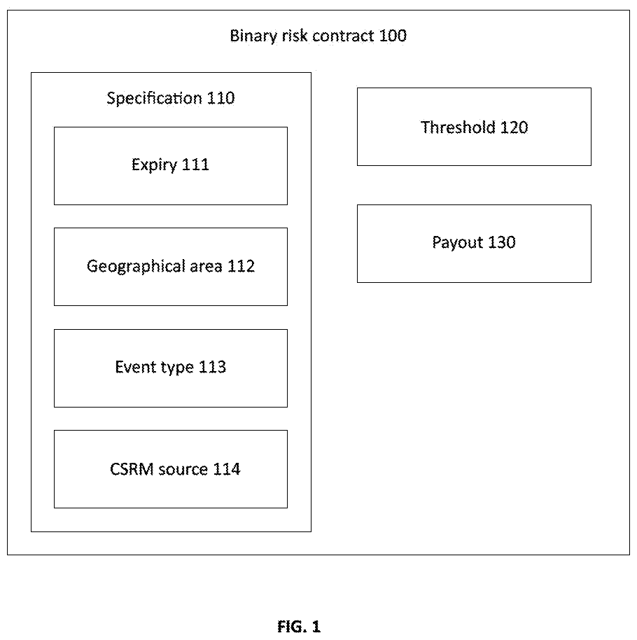

An example of a FRC is shown in FIG. 1. The example FRC 100 comprises a specification 110, a threshold 120, and a payout 130.

The specification 110 defines which events are considered by the FRC. Only those claims which meet the requirements of the specification 110 form the CSRM for the contract. The specification 110 comprises one or more of expiry 111, geographical area 112, event type 113, and CSRM source 114.

The expiry 111 delimits the dates or times for the CSRM. Where the CSRM comprises a factor relating to insurance claims (such as EICA), the expiry 111 may delimit which claims may form the EICA for the contract. The expiry may relate to when the claim is accepted or another stage in the claim lifecycle: if the claim is accepted before expiry, then that claim may form part of the EICA. This provides a high level of certainty of whether the threshold is met: once the expiry passes, the EICA will not change.

In some cases, the expiry may relate to when the damage occurs: if the damage occurs before expiry, then that damage may form part of the EICA of the CSRM. The expiry may alternatively relate to when the claim is made: if the claim is made before the expiry, then that claim may form part of the EICA when the claim is accepted. In this case, there may be a delay between when the expiry 111 passes and when it can be decisively determined that the threshold has not been passed.

The geographical area 112 specifies one or more locations to which the CSRM relates. This may be specified using terminology or a format common to insurance claims or another form. For example, “Mississippi Delta” may be used as geographical area 112 if existing insurance policies define a geographical area in that manner. In some cases, geographical area 112 may correspond to a defined political area, such as “Florida”. In other cases, the geographical area 112 may be specified in terms of a series of coordinates (such as GPS coordinates) defining an area or a geofence. The geographical area 112 may alternatively be multiple non-contiguous locations.

The event type 113 specifies the types of event to which the CSRM relates. This may be specified using terminology or a format common to insurance claims. For example, “hurricane” or “earthquake” may be used as an event type 113. In some cases, the event type may provide objective characteristics of the event type. For example, the event type may be “one-minute maximum sustained winds of at least 50 metres per second”. The formulation of such objective characteristics may match the data provided by one or more external sources.

The CSRM source 114 specifies the sources from which the CSRM is assessed. The CSRM source 114 may list insurers, reinsurers, industry bodies, government bodies, or any other independent sources of data. The CSRM source 114 may be limited to only those sources which provide verifiable or timely data.

The specification 110 may be defined using a computer-readable format, such as XML, JSON, or another data format. This can enable automated processing of FRCs and minimise the risk of human-introduced errors.

The different parameters of the specification 110 may be used to minimise or eliminate the basis risk when FRCs are used as part of hedging. By selecting a specification 110 which closely matches the underlying risk of the party (such as existing re-insurance liabilities in the case of reinsurers), the FRC can provide a tool for mitigating this risk.

The threshold 120 defines the amount at which the total quantum of CSRM will trigger the contract to payout to the long party. The threshold 120 is an amount expressed in an appropriate currency for the CSRM.

For example, the currency may be United States dollars. Where an accepted claim is in another currency, this may be converted into the threshold currency using a market exchange rate at the time the claim was accepted (or another predetermined time). This avoids later fluctuations in exchange rates from impacting the quantum of the CSRM.

In some cases, the potential range of the threshold 120 might be limited to a function of historical quanta of CSRM. For example, the threshold 120 may be limited to a maximum of twice the historical CSRM quantum for a comparable specification 110.

The payout 130 defines the amount paid to the long party if the total quantum of the CSRM reaches the threshold 120. The payout 130 is an amount expressed in an appropriate currency, which may be the same as the currency of the threshold 120. In some cases, the payout 130 is defined in non-currency terms. For example, the payout 130 may be assets such as cryptocurrency, shares, or bonds.

### Establishing a FRC

In order to establish a FRC, two or more parties typically need to come to an agreement over the FRC. In some cases, the specification 110, threshold 120, and payout 130 are set by one party with a premium being negotiated between the long party and short party. The premium is the amount paid to the short party in return for their guarantee to make the payout if the FRC's threshold is met. For example, the long party may be an insurer or reinsurer which sets the specification 110, threshold 120, and payout 130 based on its risk profile in order to minimise its basis risk.

In another case, an entity (such as the exchange) may operate as a marketmaker. In this case, the specification 110, threshold 120, and payout 130 may be set by the marketmaker, and either accepted or declined by the relevant counterparty.

In such cases, the exchange may maintain its own insurance policy, which may be relatively long-dated. This can be used to mitigate the capital exposure risks that come from acting in an exchange capacity.

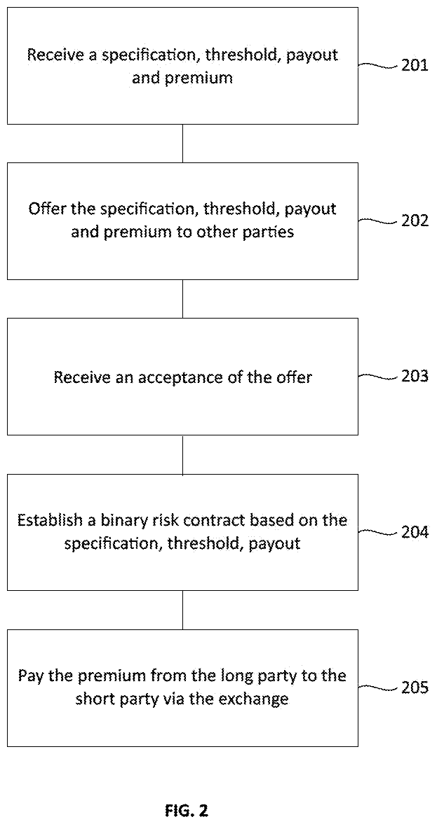

FIG. 2 shows an example of how establishing a FRC may be facilitated by an exchange.

At step 201, an exchange receives a specification 110, threshold 120, payout 130, and premium. This may be received through a user interface, such as a website or app, or may be provided through a computer interface such as an API.

In some cases, the data are received from a party which intends to be the long party or the short party of the FRC. In this case, the specification 110, threshold 120, payout 130, and premium may be set based on the individual needs of the party. Alternatively, the data may be received from a third party (or calculated by the exchange itself) which does not intend to be a party to the FRC. For example, an exchange may maintain offers for common specifications permanently open.

At step 202, the exchange offers the specification 110, threshold 120, payout 130, and premium to one or more other parties. This may occur by passively listing the offer on the exchange and/or by directly contacting one or more other parties. In some cases, this may be an automated process in which the exchange communicates with systems of the one or more other parties.

At step 203, the exchange receives an acceptance of the offer. Where the offer was made at step 201 by a party to the FRC, an acceptance of the offer requires the acceptance by the single counterparty. Where the offer was made at step 201 by a third party or the exchange, an acceptance of the offer may require the acceptance both by a prospective long party and a short party.

At step 204, the FRC is established. The exchange may store the FRC and identities of the parties to the FRC. This may occur in a public or private register in order to manage payments.

At step 205, the premium from the long party is paid by the exchange to the short party. This may occur at or immediately after step 204. This may occur by the exchange instructing a clearing house or other asset management module to transfer the corresponding funds to the short party. This may require that the exchange is satisfied as to the margin of the long party.

In this way, FRCs can be established in a transparent manner which meets both parties' needs.

### Determining the CSRM

In order to determine the CSRM for a FRC, the data from the relevant sources must be provided to the exchange. For example, when the CSRM comprises EICA or IDA, this data may come directly from the sources, or may be routed via one or more intermediaries or other parties. The data may be anonymised or aggregated for privacy reasons.

When the exchange receives the data, the exchange determines whether those data form the CSRM for each of its FRCs. Where there are multiple FRCs with different specifications managed by the exchange, the exchange determines which of its FRCs each part of the data corresponds to. This process comprises determining that the data satisfy the specification of the FRC.

Where the specification of the FRC has a geographical area, the exchange determines that the data correspond to the specified geographical area. Where the specification of the FRC has an event type, the exchange determines that the data correspond to that event type.

In some cases, this may require interpretation or interpolation of the data. This may be particularly important where the terminology or format of the data differs from that of the FRC.

In order to minimise the risk of manipulation, the exchange may make public all the data it relies on. This may occur by publishing the data to a ledger or the like. In this way, any party can verify the processing that the exchange performs and can independently calculate the CSRM for a contract. This may enhance the trustworthiness of the system by minimising the perception of risk that any manipulation could occur.

### Trading

During the life of the FRC, the long party or the short party may trade the FRC to a new short party or long party. This may occur in exchange for a new premium, which may be different from the previous premium, and may be executed in a different amount. The new premium occurs through negotiation between the parties (using conventional market approaches on the exchange). In some cases, the FRC may be parcelled as a portion of an existing FRC or as an amalgamation of multiple existing FRCs.

If the FRC's threshold is met (that is threshold for the FRC is met by the total quantum of the CSRM), it is the short party at the time the threshold is met who is responsible for covering the payout and it is the long party at the time the threshold is met who receives the payout. Thus the liability or entitlement associated with the FRC can be traded as with conventional financial instruments.

### Settlement

If the FRC's threshold is met (that is, if the threshold for the FRC is met by the total quantum of the CSRM before expiry), the long party is entitled to the payout. In some cases, this will occur immediately when the threshold is met. When this occurs, the exchange will issue its final margin demand, and once this margin demand is met, can direct a clearing house or other asset management module to transfer the payout to the long party.

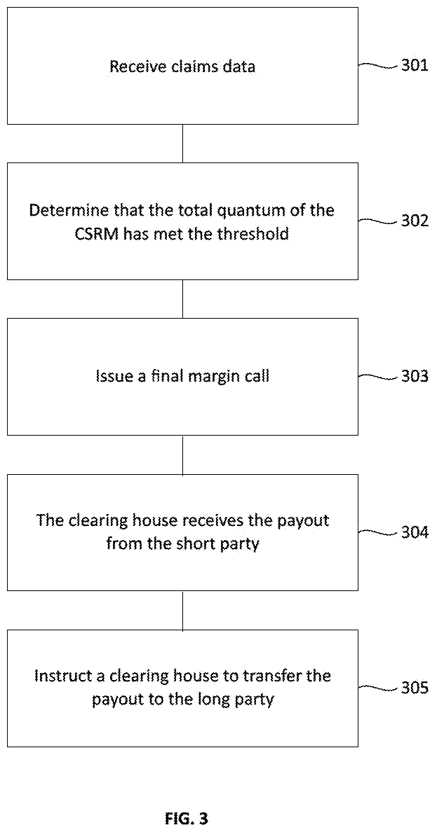

FIG. 3 shows an example of the settlement process.

At step 301, the exchange receives data relating to the CSRM. The data come from the one or more CSRM sources in the specification of the FRC.

At step 302, the exchange determines that the total quantum of the CSRM has met the threshold of a FRC before expiry.

At step 303, the exchange issues a final margin call. In some cases, the exchange may already have margin to cover the payout due to earlier calls. In such a case, step 303 may be omitted.

At step 304, the clearing house receives the payout from the short party. This may have already occurred if the exchange holds sufficient margin.

At step 305, the exchange instructs a clearing house to transfer the payout to the long party.

Minimising payment delay by efficaciously seeking IDA after an event, or by streamlining margining with the exchange's own insurance provisional contract payments will mean that the contracts have utility for the industry and perform a valuable social function.

### Expiry

The FRC expires if the total quantum of the CSRM has not met the threshold before expiry. At this point, the exchange simply notes the FRC as having expired.

The short party has already received the premium in return for taking on the potential liability of the payout. The short party becomes free of its liability under the FRC at expiry.

The long party has already paid the premium in return for receiving the potential payout. Since this did not occur, the long party does not receive a payout.

### Short FRC

Although the FRC described above has been configured such that the payout is made where the threshold has been reached before expiry, in some cases the FRC may be configured such that the payout is made where the threshold has not been reached at expiry. In this case, the payout may be made to the short party by the long party and the premium at establishment paid to the long party by the short party. In such a configuration, settlement occurs only at expiry.

### Margin

Once a FRC is established, the short party may potentially be required to make the payout. In order to mitigate the risk that the short party will default on this, the short party may be required to meet a margin. The margin is set as a proportion of the payout of the FRC and other factors.

In some cases, the margin may be set according to a predetermined figure. For example, the margin may be 100%. Alternatively, the margin may be set according to the risk inherent to the short party. A retail investor may have a 100% margin, while a well-capitalised institutional investor may have a much lower margin.

In some cases, the margin may be set dynamically and may vary across the life of the FRC.

One approach to dynamic margining is to vary the margin based on the expected probability that the threshold will be met by the total quantum of the CSRM. This probability may be assessed based on one or more data points that become available over the life of the FRC. For example, hurricane seasonality may see margins increase as the season approaches.

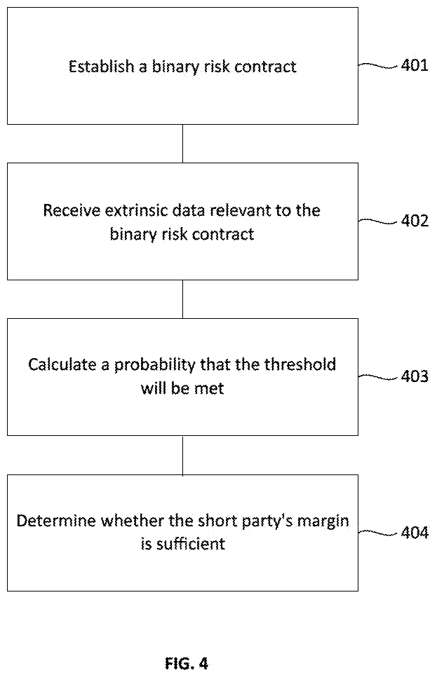

FIG. 4 shows an example of dynamic margining. This is performed by the exchange and/or its clearing house.

At step 401, the exchange and/or its clearing house establishes a FRC. This may be performed according to the approach shown in FIG. 2.

At step 402, the exchange and/or its clearing house receives extrinsic data relevant to the FRC. The scope of extrinsic data relevant to a FRC can include market price data, environmental data, meteorological data, seismic data, economic data, the prices or other analytics for securities, news events, or any sort of data which has an effect on the IDA or EICA. In addition, the exchange receives IDA or EICA data: that is, data corresponding to the event insured claims accepted.

At step 403, the exchange and/or its clearing house calculates a probability that the threshold of the FRC may be met by the total quantum of CSRM based on the extrinsic data. This may occur by passing the data to a suitably configured model. The model may be an artificial intelligence or other analytic system (such as a neural network) trained on the various sources of extrinsic data. The purpose of the model is to determine a probability, given the extrinsic data available, that the threshold of the FRC will be met. In some cases, the probability may further be based on seasonality and other factors.

Step 402 and 403 may be performed continuously or periodically to ensure that the margin for the FRC is accurate.

At step 404, the exchange and/or its clearing house determines whether the short party's margin is sufficient. This may require payment of an appropriate maintenance margin for the short party based on the extrinsic data.

If the short party's margin is not sufficient, the exchange can require that the short party provide further funds to escrow. If the short party's total margin is above the required total margin, the short party may be allowed to withdraw funds from escrow.

Since the probability may vary frequently (depending on the rate at which new data become available), the probability may be weighted or averaged over a period. This can smooth fluctuations and reduce the overhead in margin management. In some cases, there may be seasonality in margining. For example, the hurricane or typhoon season may cause an automatic increase in margin.

Using this dynamic margining approach the risk that the short party will default on the FRC is mitigated. This occurs without unnecessarily tying up the short party's capital (in the way that an inflexible 100% margin requirement would). This provides for a highly reliable instrument with minimal overhead. An efficient tokenised settlement system can allow for securities held in margined escrow accounts to accrue back to their holders without a significant “haircut” from the exchange.

An example of the dynamic margining approach may be seen in relation to a FRC for hurricane events.

Once a FRC is established corresponding to hurricane events at step 401, the exchange may receive data relevant to the FRC at step 402. For example, the risk that a hurricane occurs and causes damage is extremely closely correlated with wind speed and may be mildly correlated with sea surface temperatures over time. As data in relation to either of these points become available, the probability that a hurricane event will cause damage changes, and this in turn changes the probability that threshold of the FRC may be met by the total quantum of CSRM (that is, the probability of payout).

Thus, if the exchange receives new sea surface temperature, the exchange may calculate at step 403 that the probability of payout has increased to 0.01. In this case, the exchange may require a margin of 1% of the payout.

If the exchange subsequently receives wind speed data at step 402, the exchange may calculate at step 403 that the probability of payout has increased to 0.3. In this case, the exchange may require a margin of 30% of the payout.

If the exchange starts to receive CSRM data indicating that the corresponding CSRM is increasing, the probability of payout may increase to 0.6. In this case, the exchange may require a margin of 60% of the payout.

Once the CSRM data indicates that the CSRM has met the threshold, the probability of payout can be calculated as 1 (since the threshold cannot subsequently be unmet). In this case, the short party is required to provide the full payout immediately so that this can be provided to the long party.

### FRC Portfolio

Because FRCs are, for the most party, statistically uncorrelated (except when they share similar or identical specifications of geographical location and event type), a portfolio of FRCs may require a low margin. For example, a portfolio of FRCs which covers many geographical locations and event types may require a relatively small margin.

For example, given 100 FRCs of the same payout, a 5% margin might be sufficient to margin for five of the thresholds of the FRCs being met.

Within such a portfolio, the holder may be able to manage each individual FRC separately. This might be used to manage losses or trade across risk if it appears a FRC is likely to pay out. Portfolios might equally be passively managed and closed out once the margin falls below the sum of a predetermined number (such as two) of the largest FRCs.

This uncorrelated portfolio effect can be socially beneficial through the balancing function that pushes capital into smaller markets.

The exchange may wish to be covered on exposure to the largest uncorrelated risks held by one party, but may be content to margin parties below that. Where risks are correlated, the exchange may adjust this rate.

### Application to Insurers and Reinsurers

In one particular implementation, the approaches noted above may be utilised in the context of insurance and reinsurance. In such a case, a set of FRCs may be used to hedge against the risk that a large loss will be incurred in response to a catastrophic event, such as a hurricane or earthquake.

In this implementation, an insurer or a reinsurer identifies a risk profile based on its potential insurance liabilities. Based on this analysis, the insurer or reinsurer identifies one or more sets of specifications, thresholds, and payouts. For example, a reinsurer may identify a particular risk of USD 1 billion in potential liability occurring over an upcoming week for hurricanes in Florida. The reinsurer may also calculate that it could absorb a liability of $600 million. The insurer may wish to issue one or more FRCs to cover the difference. This results in a specification (that is, a geographical area of Florida, an event of hurricanes, an expiry of one week, and a CSRM source based on its liabilities), a threshold of $600 million and a payout of $400 million. When FRCs are of identical total specification, they are fungible with each other and can be traded in any denomination between multiple counterparties.

This FRC (or set of FRCs) is then established with the reinsurer as the long party and one or more retail or institutional investors as the short party. In return for the premium, the reinsurer hedges its risk against an otherwise potentially catastrophic loss.

If the hurricane occurs in Florida and causes a CSRM of more than $600 million in damage, the threshold for the FRC (or set of FRCs) is reached. The payout is transferred to the long party (that is, the reinsurer) to cover the FRC liability.

If the hurricane does not occur or the damage is below the threshold within the timeframe of the FRC, the FRC (or set of FRCs) expires. The reinsurer suffers no further loss: loss is limited to the premium already paid.

In this way, FRCs offer a convenient way for insurers or reinsurers to hedge risk against otherwise catastrophic losses.

In some cases, FRCs may additionally or alternatively be used to diversify capital from unrelated financial sectors outside of the insurance or reinsurance sector.

### System

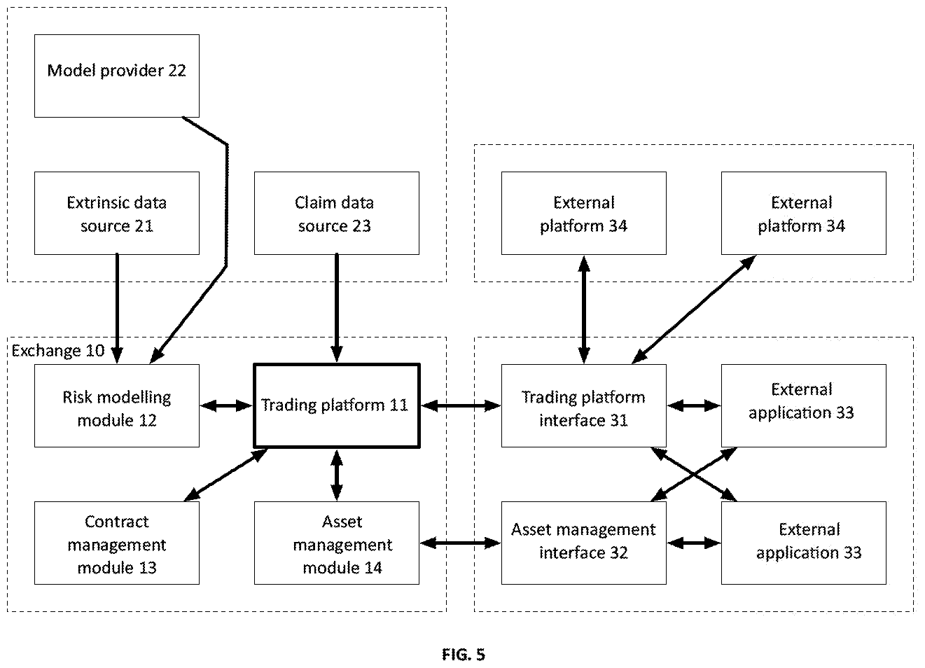

FIG. 5 shows an example system in which the described methods can be implemented.

The exchange 10 comprises a trading platform 11. The trading platform provides the core of the exchange with respect to establishing FRCs. The trading platform further administers margining for FRCs. Some part of the function of the trading platform 11 may be delegated to a clearing house.

A risk modelling module 12 of the exchange 10 can communicate with extrinsic data sources 21 and loss model providers 22. In this manner, the risk modelling module 12 may perform steps 402 and 403.

A contract management module 13 can be used to store and maintain established FRCs. In this manner, the contract management module 13 can be used in performing step 203. The asset management system 14 can be used to handle payouts and margins. In this manner, the asset management module 14 can be used in performing steps 303 and 304.

The trading platform 11 further interacts with one or more sources 23 of claims data. This can be used to determine the CSRM for a FRC, and consequently can be used in performing steps 301 and 302.

The trading platform provides an interface 31 and the asset management module 14 provides an interface 32. These allow external applications 33 (such as websites or apps) or other platforms 34 (such as brokerage or reinsurance platforms) to interact with the system. This provides a level of flexibility in terms of how users can interact with the system.

In practice, each of the modules may be distributed across one or more computer systems, or multiple modules may be combined into a single computer system.

### Interpretation

A number of methods have been described above. It will be appreciated that any of these methods may be embodied by a series of instructions, which may form a computer program. These instructions, or this computer program, may be stored on a computer readable medium, which may be non-transitory. When executed, these instructions or this program may cause a processor, such as a CPU, to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The order of steps within methods may be altered, such that steps are performed out of order or in parallel, except where one step is dependent on another having been performed, or the context otherwise requires.

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments and with reference to the drawings, the invention is not intended to be restricted to such details. Additional advantages and modifications will readily appear to those skilled in the art. Therefore, the invention in its broader aspects is not limited to the specific details, representative apparatuses and methods, and illustrative examples shown and described. Accordingly, departures may be made from such details without departure from the spirit or scope of the general inventive concept.

1. A computer-implemented method comprising:
receiving data;
determining that the data match a specification of a fixed risk contract;
determining, based on the data, that a threshold of the fixed risk contract has been met, wherein the threshold comprises a total quantum of a contract settlement reference methodology meeting the specification of the fixed risk contract; and
triggering a payout of the fixed risk contract in response to the determination that a threshold of the fixed risk contract has been met.

2. The method of claim 1, wherein the data comprise accepted claims and is received from one or more of:
one or more insurers;
one or more reinsurers; or
one or more industry bodies.

3. The method of claim 1, wherein the specification of the fixed risk contract comprises a geographical area and an event.

4. The method of claim 3, wherein determining that the data match a specification of a fixed risk contract comprises:
determining that the data are derived from an event matching the event in the specification of the fixed risk contract; and
determining that the data are derived from an event occurring in a location within the geographical area of the fixed risk contract.

5. The method of claim 1, further comprising:
before determining that a threshold of the fixed risk contract has been met, determining that the fixed risk contract has not expired.

6. The method of claim 1, wherein the data relate to an event which occurred before an expiry of the fixed risk contract.

7. The method of claim 1, wherein triggering a payout of the fixed risk contract in response to the determination that a threshold of the fixed risk contract has been met comprises:
instructing a short party of the fixed risk contract to make available funds for the payout; and
paying a long party of the fixed risk contract the payout.

8. The method of claim 7 wherein paying a long party of the fixed risk contract the payout comprises:
moving funds from escrow to the long party.

9. The method of claim 1, wherein the method is performed automatically by a computer system of an exchange.

10. A computer-implemented method comprising:
receiving extrinsic data;
calculating a probability that a threshold of a fixed risk contract will be met based on the extrinsic data;
calculating a margin for a short party of the fixed risk contract based on the probability.

11. The method of claim 10, wherein the extrinsic data comprise one or more of:
environmental data;
meteorological data;
seismic data;
economic data;
prices or analytics of securities; or
news events.

12. The method of claim 10, wherein calculating a probability that a threshold of a fixed risk contract will be met based on the extrinsic data comprises:
calculating a probability that a threshold of a fixed risk contract will be met based on the extrinsic data and claims data, the claims data comprising data of event insured claims accepted.

13. The method of claim 10, further comprising:
instructing a short party to provide funds based on the calculated margin.

14. The method of claim 10, wherein the calculating a margin for a short party of the fixed risk contract based on the probability comprises:
calculating a margin as a function of a plurality of calculated probabilities.

15. The method of claim 14, wherein calculating a margin as a function of a plurality of calculated probabilities comprises:
calculating a margin as an average of the plurality of calculated probabilities.

16. A computer system comprising:
one or more processors; and
a memory;
wherein the memory comprises instructions which, when executed by the one or more processors, cause the one or more processors to perform a method of claim 1.

17. One or more non-transitory computer readable media comprising instructions which, when executed by one or more processors, cause the one or more processors to perform a method of claim 1.

18. A computer system comprising:
one or more processors; and
a memory;
wherein the memory comprises instructions which, when executed by the one or more processors, cause the one or more processors to perform a method of claim 10.

19. One or more non-transitory computer readable media comprising instructions which, when executed by one or more processors, cause the one or more processors to perform a method of claim 10.
